(19) United States
(12) Patent Application Publication
(10) Pub. No.: US 2023/0024617 A1
(43) Pub. Date: Jan. 26, 2023

(54) FILM PASTING DEVICE

(71) Applicant: SHENZHEN BAITENGDA TRADING CO., LTD., Shenzhen (CN)

(72) Inventors: Fan Yu, Shenzhen (CN); Rufeng Yang, Shenzhen (CN)

(21) Appl. No.: 17/676,804

(22) Filed: Feb. 21, 2022

(30) Foreign Application Priority Data
Jul. 26, 2021 (CN) 202121725790.1
Dec. 21, 2021 (CN) 202123253497.2

(51) Int. Cl. B29C 63/02; B29C 63/00

(52) U.S. Cl. CPC B29C 63/02; B29C 63/0004; B29L 2031/3475

(57) ABSTRACT

The present invention discloses a film pasting device, comprising a main board body, the main board body is provided with a film fixed area for fixing a protective film, and a pressing hole is formed in the film fixed area on the main board body; and the film fixed area is configured to be bonded with one side, deviating from a pull-up film, of a film body of the protective film, such that the protective film is connected to the main board body as a whole; the film body is disconnected from the film fixed area when pushing the side of the protective film deviating from the pull-up film after penetrating through the pressing hole.

### CROSS REFERENCE TO RELATED APPLICATIONS

The present application claims the benefit of Chinese Patent Application Nos. 202121725790.1 filed on Jul. 26, 2021 and 202123253497.2 filed on Dec. 21, 2021. All the above are hereby incorporated by reference in their entirety.

### TECHNICAL FIELD

The present invention relates to the field of film pasting, in particular to a film pasting device.

### BACKGROUND ART

A screen of an electronic device is easily scratched during use, such as a cell phone and an iPad. With a cell phone as an example, the screen is one of the more expensive parts on the cell phone. During daily use, the screen of the cell phone is often scratched, for example, the screen is scratched when the screen is in contact with metal objects or when the screen is dropped to the ground.

In order to protect the screen of the cell phone from being scratched or broken, a screen protective film is often pasted onto the screen of the cell phone. Pasting a screen protective film onto the screen of a cell phone is technically difficult to a certain extent, therefore, the film pasting device of a cell phone emerged as an auxiliary film pasting tool.

However, the existing film pasting device is difficult in film pasting and the alignment is not accurate.

### SUMMARY OF THE INVENTION

The present invention aims at providing a film pasting device with easy film pasting and accurate alignment.

The present invention discloses a film pasting device, including: a main board body, wherein the main board body is provided with a film fixed area for fixing a protective film, and a pressing hole is formed in the film fixed area on the main board body; and

the film fixed area is configured to be bonded with one side, deviating from a pull-up film, of a film body of the protective film, such that the protective film is connected to the main board body as a whole; the film body is disconnected from the film fixed area when pushing the side of the protective film deviating from the pull-up film after penetrating through the pressing hole.

Optionally, stickers are arranged at two ends of the film fixed area along a length direction, and the stickers are configured to stick the two ends of the protective film along the length direction, and the film fixed area is bonded with the side, deviating from the pull-up film, of the film body through the stickers, such that the protective film is fixed in the film fixed area.

Optionally, the film fixed area is sunk and set as a groove area.

Optionally, a first projection is arranged on a side wall of the groove area.

Optionally, a first inclined surface is arranged at an end, far away from a bottom surface of the groove area, of the first projection.

Optionally, the first projection includes a first flat part and a first inclined part, the first inclined part is connected to an end, far away from the bottom surface of the groove area, of the first flat part; the thickness of the first inclined part gradually thickens from an end far away from the first flat part to an end near the first flat part, thereby forming the first inclined surface on the first inclined part.

Optionally, two first projections are arranged on the side wall of each side of the groove area; and the two first projections are arranged at intervals.

Optionally, the film pasting device includes a first positioning side plate and a second positioning side plate, the first positioning side plate and the second positioning side plate are arranged opposite to each other, the first positioning side plate and the second positioning side plate define the film fixed area on the main board body; and a second projection is arranged on inner side walls of the first positioning side plate and the second positioning side plate.

Optionally, a second inclined surface is arranged at an end, far away from the film fixed area, of the second projection.

Optionally, the second projection includes a second flat part and a second inclined part, the second inclined part is connected to an end, far away from the film fixed area, of the second flat part; the thickness of the second inclined part gradually thickens from an end far away from the second flat part to an end near the second flat part, thereby forming the second inclined surface on the second inclined part.

Optionally, two second projections are arranged on the inner side walls of the first positioning side plate and the second positioning side plate; and the two second projections are arranged at intervals.

Optionally, the film pasting device further includes a first positioning side plate, a second positioning side plate, a third positioning side plate and an arched bar; the first positioning side plate and the second positioning side plate are arranged opposite to each other, the first positioning side plate, the second positioning side plate and the third positioning side plate are enclosed on three sides of the film fixed area; the arched bar is arranged on the main board body and is located at a remaining side of the film fixed area, the arched bar is arched relative to the main board body to form an arched opening.

Optionally, a circle of transparent area is arranged around the pressing hole on the main board body.

Optionally, the film pasting device includes a first positioning side plate, a second positioning side plate and a fixed member, the first positioning side plate and the second positioning side plate are arranged opposite to each other, the first positioning side plate and the second positioning side plate define the film fixed area on the main board body; and the fixed member is abutted against the inner side walls of the first positioning side plate and the second positioning side plate, such that the fixed member covers the film fixed area and further fixes the protective film.

Optionally, clamping grooves are arranged on the inner side walls of the first positioning side plate and the second positioning side plate, protruding parts corresponding to the clamping grooves are arranged at two sides of the fixed member, and the protruding parts are clamped into the clamping groove and abutted against the clamping groove.

Optionally, an avoidance notch is formed at an end part of the first positioning side plate; a lifting part corresponding to the avoidance notch is arranged on the side of the fixed member; and the lifting part is arranged in the avoidance notch when the fixed member covers the film fixed area.

As to the film pasting device of the present invention, the main board body may easily cover the film pasting object, the alignment is accurate and movement does not easily occur. Through bonding between the film fixed area and the film body, the film body is convenient to be attached onto the screen, the film body may be disconnected from the film fixed area when the user pushes the side of the protective film deviating from the pull-up film after penetrating through the pressing hole, therefore, film pasting is easy and has small difficulty.

### BRIEF DESCRIPTION OF THE DRAWINGS

The accompanying drawings are included to provide a further understanding of embodiments of the present invention, which form part of the specification, to illustrate embodiments of the present invention, and to illustrate principles of the present invention together with the text description. Apparently, the accompanying drawings described below are merely some embodiments of the present invention, and other accompanying drawings may be obtained by those skilled in the art according to these drawings without any creative effort. In the accompanying drawings:

FIG. 1 is a schematic diagram of a film pasting device of an embodiment of the present invention;

FIG. 2 is a schematic diagram of a film pasting device of another embodiment of the present invention;

FIG. 3 is a schematic diagram of a film pasting device of still another embodiment of the present invention;

FIG. 4 is a schematic diagram of a film pasting device of still another embodiment of the present invention;

FIG. 5 is a schematic diagram of a film pasting device of still another embodiment of the present invention;

FIG. 6 is a schematic diagram of a film pasting device of still another embodiment of the present invention;

FIG. 7 is a partial enlarged view of part A in FIG. 6;

FIG. 8 is a schematic diagram of a film pasting device of still another embodiment of the present invention;

FIG. 9 is an exploded schematic diagram of a film pasting device in FIG. 8;

FIG. 10 is an exploded view of a protective film in FIG. 9;

FIG. 11 is a schematic diagram of a film pasting device of another embodiment of the present invention;

FIG. 12 is another schematic diagram of a film pasting device in FIG. 11;

FIG. 13 is an exploded view of a film pasting device in FIG. 11;

FIG. 14 is a schematic diagram of a film pasting device of still another embodiment of the present invention

FIG. 15 is a partial enlarged view of part A in FIG. 14;

FIG. 16 is a partial enlarged view of part B in FIG. 14;

FIG. 17 is a schematic diagram of a film pasting device of still another embodiment of the present invention.

Reference numerals in the figures: 10, assembly; 100, film pasting device; 110, main board body; 111, film fixed area; 111a, groove area; 111b, first projection; 111b1, first flat part; 111b2, first inclined part; 111b21, first inclined surface; 112, pressing hole; 113, opening; 114, raised line; 115, lug; 116, transparent area; 117, cavity; 120, first positioning side plate; 121, second projection; 121a, second flat part; 121b, second inclined part; 121b1, second inclined surface; 122, clamping groove; 130, second positioning side plate; 140, fixed structure; 141, suction cup; 142, sticker; 143, clamping block; 144, positioning projection; 150, pressing part; 160, clamping groove; 170, third positioning side plate; 180, arched bar; 181, arched opening; 190, avoidance notch; 200, projective film; 210, film body; 220, positioning plate; 221, positioning hole; 230, pull-up film; 300, fixed member; 310, protruding part; 320, lifting part.

### DETAILED DESCRIPTION OF THE EMBODIMENTS

It should be understood that the terms used herein and specific structural and functional details disclosed herein are merely intended to describe specific embodiments and are representative, but the present invention can be specifically realized in many alternative forms and should not be construed as being limited only to the embodiments set forth herein.

The present invention will be described in details below with reference to the accompanying drawings and optional embodiments.

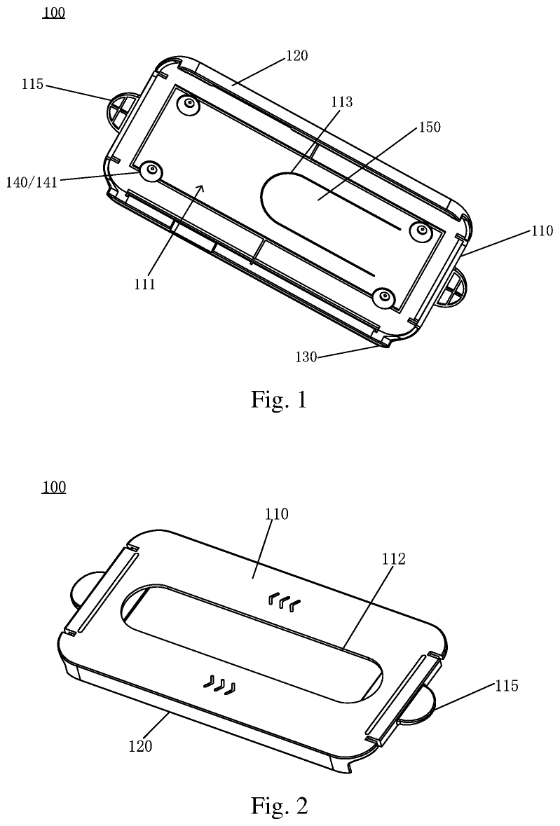

Please refer to FIG. 1 to FIG. 3 which are schematic diagrams of several embodiments of a film pasting device of the present invention, wherein the film pasting device 100 includes a main board body 110, a first positioning side plate 120 and a second positioning side plate 130; the first positioning side plate 120 and the second positioning side plate 130 are connected onto the side of the main board body 110, and the first positioning side plate 120 and the second positioning side plate 130 are opposite to each other; the first positioning side plate 120 and the second positioning side plate 130 define a film fixed area 111 on the main board body 110; the first positioning side plate 120 and the second positioning side plate 130 are configured to resist against the side of a film pasting object; a fixed structure 140 is arranged in the film fixed area 111 on the main board body 110, and the fixed structure 140 is configured to fix a positioning plate 220 of the protective film 200 on the main board body 110; and the film fixed area 111 on the main board body 110 is formed with a pressing hole 112 or provided with a deformable pressing part 150.

As to the film pasting device 100 of the present invention, the positioning plate 220 of the protective film 200 is fixed onto the main board body 110 through the fixed structure 140, and the film pasting device 100 covers the screen of the film pasting object. At this time, the first positioning side plate 120 and the second positioning side plate 130 are arranged on the side of the film pasting object, to play a role of resisting, and to prevent movement of the film pasting device 100, and the protective film 200 located in the film fixed area 111 may be aligned with the screen of the film pasting object. An operator presses the positioning plate 220 after penetrating through the pressing hole 112 or through the deformable pressing part 150, and may pick up the film pasting device 100 to finish film pasting after the film body 210 of the protective film 200 is attached onto the screen.

The film pasting device 100 of the present invention is defined by the first positioning side plate 120 and the second positioning side plate 130 and is directly pressed by the pressing hole 112 or the pressing part 150, and the film body 210 of the protective film 200 may be attached onto the screen at an accurate position, thereby lowering the difficulty in film pasting and providing a favorable film pasting effect.

In the present invention, the first positioning side plate 120 and the second positioning side plate 130 are configured to position the film pasting device 100 to prevent it from moving, and the pressing hole 112 or the pressing part 150 can conveniently paste the film body 210 of the protective film 200 onto the screen. Both of them work together to reduce the difficulty in film pasting and provide a favorable film pasting effect.

As shown in FIG. 10, the protective film 200 includes at least a positioning plate 220 and a film body 210, and the positioning plate 220 is attached onto the film body 210. The positioning plate 220 is used for positioning fit, and the film body 210 on the protective film 200 is ultimately attached onto the film pasting object, and the film body 210 is for example a tempered film.

As to a specific implementation of the fixed structure 140, the fixed structure 140 may be a suction cup 141. The suction cup 141 sucks the positioning plate 220 of the protective film 200 in place. The user presses the positioning plate 220 of the protective film 200 after penetrating through the pressing hole 112 or through the pressing part 150, and the positioning plate 220 of the protective film 200 is pressed, and the film body 210 of the protective film 200 is attached onto the screen. When the film pasting device 100 is removed, the positioning plate 220 of the protective film 200 is separated from the film body 210 and film pasting is completed. The suction cup 141 is firmly adsorbed to facilitate separation of the positioning plate 220 from the film body 210.

As to a specific implementation of the fixed structure 140, in other embodiments, as shown in FIG. 4, the fixed structure 140 may be a sticker 142. The sticker 142 may stick the positioning plate 220 of the protective film 200, and the operator presses the protective film 200 through the pressing hole 112. The sticker 142 is firmly fixed and facilitates the separation of the positioning plate 220 from the film body 210.

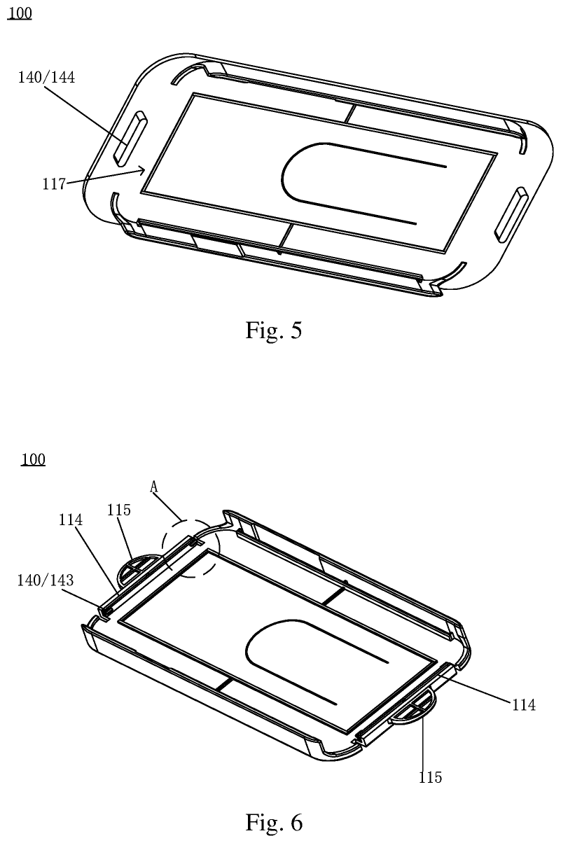

As to a specific implementation of the fixed structure 140, in other embodiments, as shown in FIG. 5, the fixed structure 140 may be a positioning projection 144, and the positioning projection 144 is configured to match with the mating holes of the positioning plate 220 of the protective film 200. The positioning plate 220 is provided with mating holes, and the positioning projection 144 is inserted into the mating holes, thereby fixing the protective film 200 in the film fixed area 111. The positioning projection 144 is easily fixed, and the positioning plate 220 may be easily removed from the positioning projection 144 after the film pasting operation is completed.

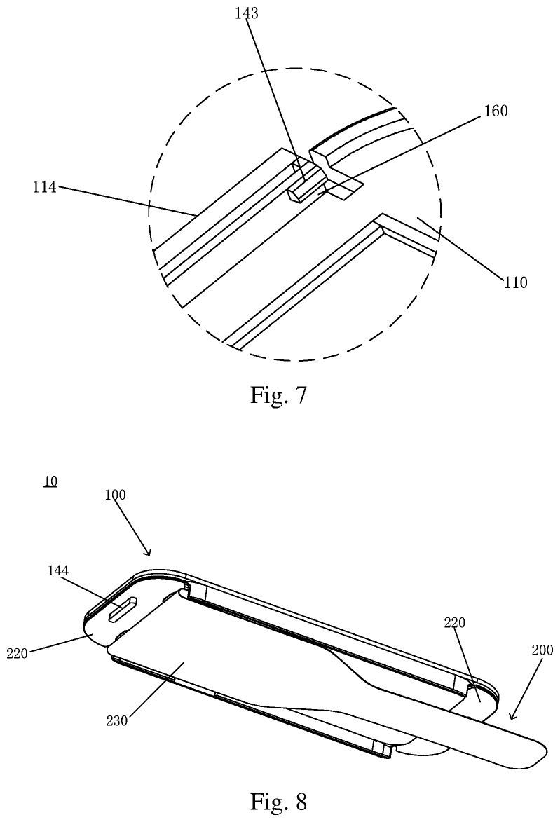

As to a specific implementation of the fixed structure 140, in other embodiments, as shown in FIG. 6 and FIG. 7, the fixed structure 140 may be a clamping block 143. The clamping block 143 enables the positioning plate 220 of the protective film 200 to be clamped in the film fixed area 111, and the clamping block 143 is conveniently fixed, and the positioning plate 220 may be easily removed from the positioning projection 144 after the film pasting operation is completed. More specifically, a raised line 114 is arranged on one side of the main board body 110 and the opposite other side, and the clamping block 143 is arranged on the inner side of the raised line 114; and a clamping groove 160 is formed between the clamping block 143 and the main board body 110. The inner side of the raised line 114 is the side facing the film fixed area 111, and the outer side is the side deviating from the film fixed area 111. In the present solution, the clamping groove 160 formed by the clamping block 143 is configured to clamp the positioning plate 220 of the protective film 200 and facilitate film pasting. More specifically, two clamping blocks 143 are available for each raised line 114, i.e., each end may provide two clamping points, and the protective film 200 is not easily shaken and is better fixed.

A cavity 117 configured to accommodate and define the film pasting object (that is, an electronic device) is formed above the film fixed area of the main board body. By nesting the cavity 117 with the film pasting object, the main board body may easily cover the film pasting object with accurate alignment and no easy movement.

On the other hand, as shown in FIG. 3, the main board body 110 is formed with an opening 113, and the pressing part 150 is arranged in the opening 113 and is partially connected to the main board body 110. In the present solution, the pressing part 150 is only partially connected to the main board body 110, and the pressing part 150 is more easily deformed and pressed with less effort. In other embodiments, the pressing part 150 and the main board body 110 are integrally formed. In the present solution, the pressing part 150 and the main board body 110 are integrally formed, which provides better structural strength and is less prone to damage.

More specifically, the pressing part 150 may be made of deformable plastic, rubber, silicone or film, etc., as long as it has the ability to deform.

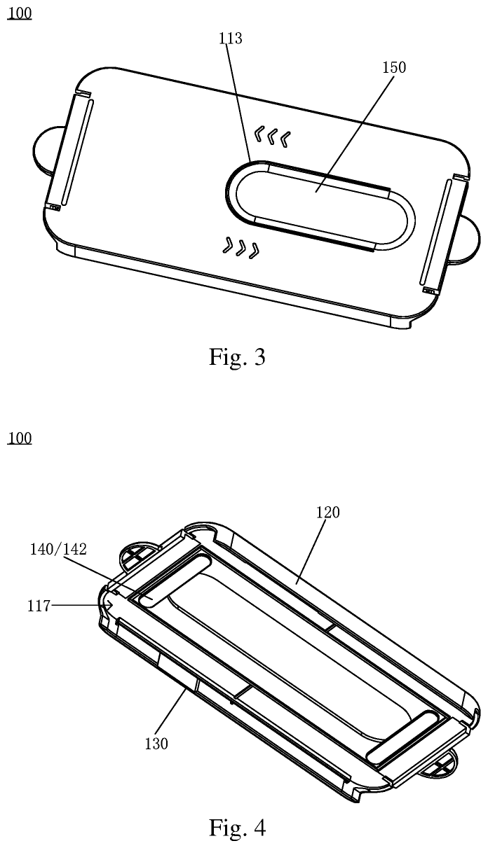

Further, as shown in FIG. 1 and FIG. 2, the main board body 110, the first positioning side plate 120 and the second positioning side plate 130 are made of soft materials, and the outer side of the raised line 114 is provided with lugs 115. The lugs 115 can be grasped by the operator, and during film pasting, the operator grasps the lugs 115 and folds up the main board body 110, the first positioning side plate 120 and the second positioning side plate 130, such that the positioning plate 220 and the film body 210 may be separated quickly and film pasting is facilitated.

The main board body 110 is made of transparent materials. In the present solution, the main board body 110 is made of transparent materials, which can facilitate the operator to observe film pasting and ensure that the time of taking away the main board body 110 is accurate.

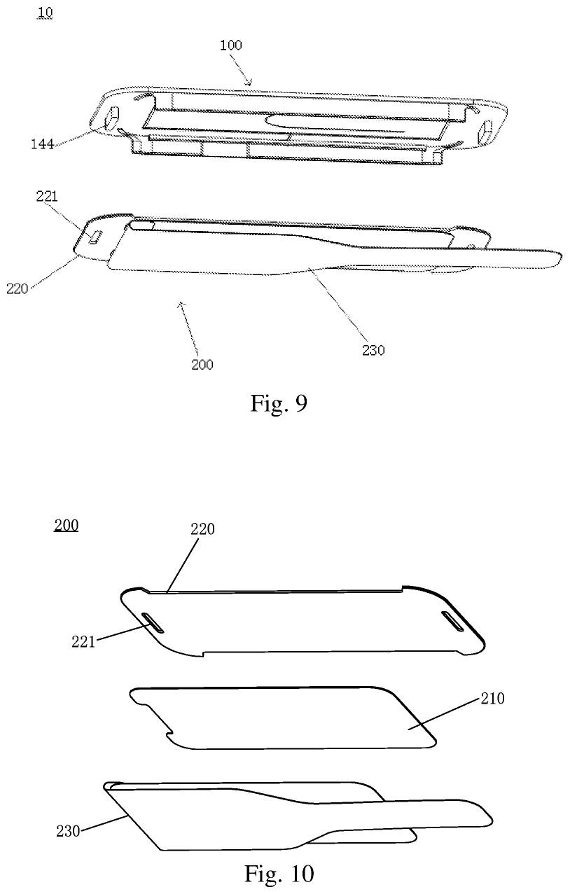

As shown in FIG. 8 to FIG. 10, as another embodiment of the present invention, the film pasting device 100 may form an assembly 10 with the protective film 200. The protective film 200 includes a film body 210 and a positioning plate 220; and the positioning plate 220 is attached onto the film body 210, and the positioning plate 220 is configured to be matched with the fixed structure 140, to fix the protective film 200 onto the main board body 110.

As to the film pasting device 100 of the present embodiment, through the defining by the first positioning side plate 120 and the second positioning side plate 130, the fixed structure 140 fixes the protective film 200, and through the pressing hole 112 or direct pressing by the pressing part 150, the film body 210 of the protective film 200 may be attached onto the screen at an accurate position, thereby lowering the difficulty in film pasting and providing convenient film pasting and a favorable film pasting effect.

Specifically, the positioning plate 220 is provided with a positioning hole 221, and the fixed structure 140 is a positioning projection 144; the positioning projection 144 is configured to be inserted into the positioning hole 221 to fix the protective film 200 onto the main board body 110. The positioning plate 220 is provided with a mating hole, and the positioning projection 144 is inserted into the mating hole, so as to fix the protective film 200 in the film fixed area 111. The positioning projection 144 is conveniently fixed, and the positioning plate 220 may be easily removed from the positioning projection 144 after the film pasting operation is completed.

Specifically, the protective film 200 includes a pull-up film 230; the pull-up film 230 is attached onto the film body 210 and is located on the other side of the face in which the positioning plate 220 is located; one end of the pull-up film 230 is folded in a reverse direction and is extended; the reversely folded end of the pull-up film 230 extends out of the main board body 110 when the protective film is fixed to the main board body 110. The pull-up film 230 is a protective layer of the film body 210, and is attached onto the film body 210 to prevent dust before the film body 210 is used. As shown in FIG. 8, the pull-up film 230 is attached onto the film body 210 and then folded in half. In this way, the operator may directly pull the folded portion of the pull-up film 230, to directly remove the pull-up film 230 from the film body 210. Moreover, when the protective film 200 covers above the screen, the reversely folded end of the pull-up film 230 extends out of the main board body 110, so that the pull-up film 230 may be removed after the protective film 200 covers above the screen, thereby ensuring that the film body 210 is protected by the pull-up film 230 before the film body 210 is pasted, and that the film body 210 may be pasted onto the screen immediately after the pull-up film 230 is removed, such that the side attached onto the screen is not easily stained with dust. When the reversely folded end of the pull-up film 230 extends out of the main board body 110, the operator may pull the pull-up film 230 after covering the screen with the film pasting device 100.

As to the film pasting device of the present invention, the main board body is bonded with the film body 210 through a film fixed area 111, facilitating attachment of the film body 210 onto the screen, the film body 210 may be disconnected from the film fixed area 111 when the user pushes the side of the protective film 200 deviating from the pull-up film 230 after penetrating through the pressing hole 112, therefore, film pasting is easy and the difficulty in film pasting is small.

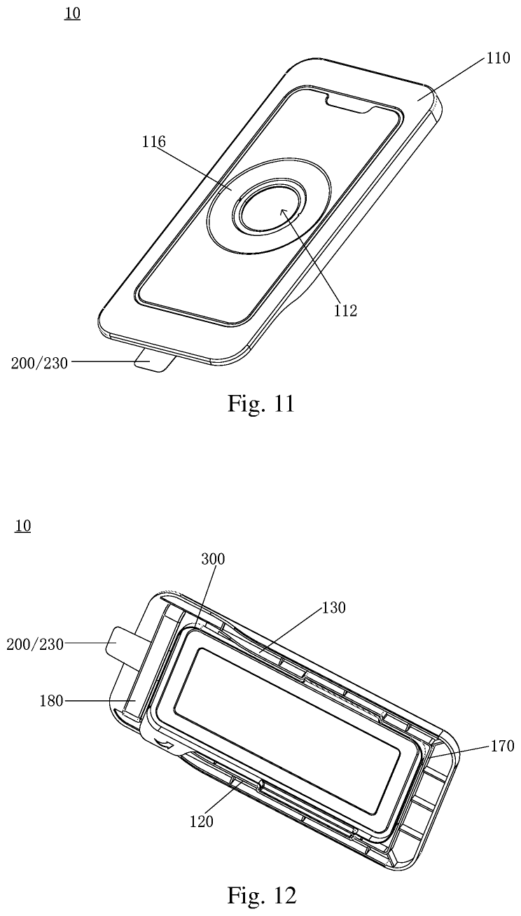

The present invention further discloses a film pasting device, as shown in FIG. 11 to FIG. 13, the film pasting device 100 includes a main board body 110, the main board body 110 is provided with a film fixed area 111 for fixing the protective film 200; a pressing hole 112 is formed in the film fixed area 111 on the main board body 110; the film fixed area 111 is configured to be bonded with the side, deviating from the pull-up film 230, of the film body 210 of the protective film 200, such that the protective film 200 is connected to the main board body 110 in a whole; the film body 210 is disconnected from the film fixed area 111 when pushing the side of the protective film 200 deviating from the pull-up film 230 after penetrating through the pressing hole 112.

Specifically, stickers 142 are arranged at two ends of the film fixed area 111 along a length direction, and the stickers 142 are configured to stick the two ends of the protective film 200 along the length direction, and the film fixed area 111 is bonded with the side, deviating from the pull-up film 230, of the film body 210 through the stickers 142, such that the protective film 200 is fixed in the film fixed area 111.

In the present solution, stickers 142 are arranged at two ends of the film fixed area 111 along a length direction, and the stickers 142 stick the two ends of the protective film 200 along the length direction, in this way, the user presses the protective film 200 through the pressing hole 112 with a finger during operation, such that the middle area of the film body 210 on the protective film 200 is firstly attached onto the screen. At this time, since the two ends of the protective film 200 are stuck by the stickers 142, therefore, the film body 210 on the protective film 200 is gradually attached onto the screen from the middle area to the two ends, until the two ends of the film body 210 of the protective film 200 fall off from the stickers and are completely attached onto the screen. In such an attaching process, air between the film body 210 and the screen will be discharged in turn, no bubbles are easily generated during film pasting, the difficulty in film pasting is small, and the film pasting effect is favorable.

In addition, the pressing hole 112 is formed in the film fixed area 111, and the user may conveniently pick up the film pasting device 100 directly when pressing the protective film 200 onto the screen with a finger penetrating through the pressing hole 112, the operation is convenient.

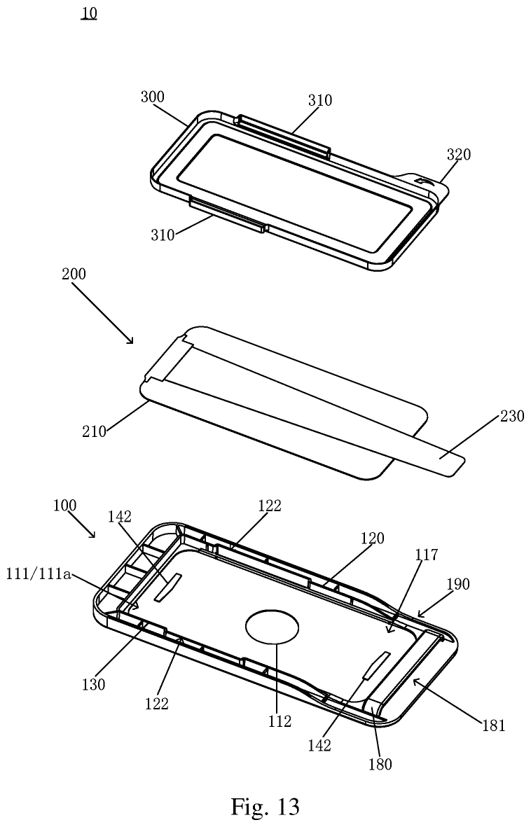

Optionally, as shown in FIG. 13, the film fixed area 111 is sunk and set as a groove area 111a; the groove area 111a allows positioning of the protective film 200, to facilitate accurate fixation of the protective film 200 onto the film fixed area 111 and also allows movement of the protective film 200.

Optionally, as shown in FIG. 13, a first projection 111b is arranged on the side wall of the groove area 111a. Since a machining error exists when the groove area 111a is machined, and the machined groove area 111a is difficult to position the protective film 200 well. In the present solution, a first projection 111b is arranged on the side wall of the groove area 111a, and the first projection 111b may reduce the machining error and position the protective film 200 well. In addition, the first projection 111b is arranged to allow a large gap between the edge of the protective film 200 and the side wall of the groove area 111a, such that when the protective film 200 is attached onto the film fixed area 111, air therein may be quickly discharged through the gap and the protective film 200 is fixed conveniently.

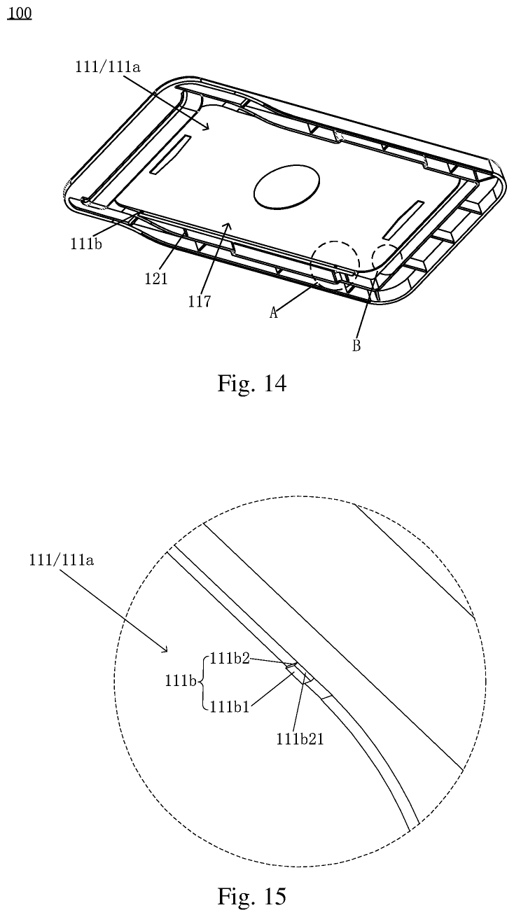

Optionally, as shown in FIG. 14 to FIG. 15, a first inclined surface 111b21 is arranged on a side, far away from a bottom surface of the groove area 111a, of the first projection 111b. In the present solution, the first inclined surface 111b21 may play a role of guiding, to facilitate fixation of the protective film 200.

Optionally, as shown in FIG. 15, the first projection 111b includes a first flat part 111b1 and a first inclined part 111b2, the first inclined part 111b2 is connected to an end, far away from the bottom surface of the groove area 111a, of the first flat part 111b1; the thickness of the first inclined part 111b2 gradually thickens from an end far away from the first flat part 111b1 to an end near the first flat part 111b1, thereby forming the first inclined surface 111b21 on the first inclined part 111b2. In the present solution, the first inclined part 111b2 may play a role of guiding, to guide the protective film 200 to the first flat part 111b1, and the first flat part 111b1 may well position the protective film 200.

Optionally, as shown in FIG. 14 and FIG. 17, two first projections 111b are arranged on the side wall of each side of the groove area 111a; and the two first projections 111b are arranged at intervals. In the present solution, two first projections 111b are arranged on the side wall of each side of the groove area 111a, to position the protective film 200 from all sides and have a good positioning effect; while the two first projections 111b are arranged at intervals to make the positioning of each side stable without shaking, and the positioning effect is favorable.

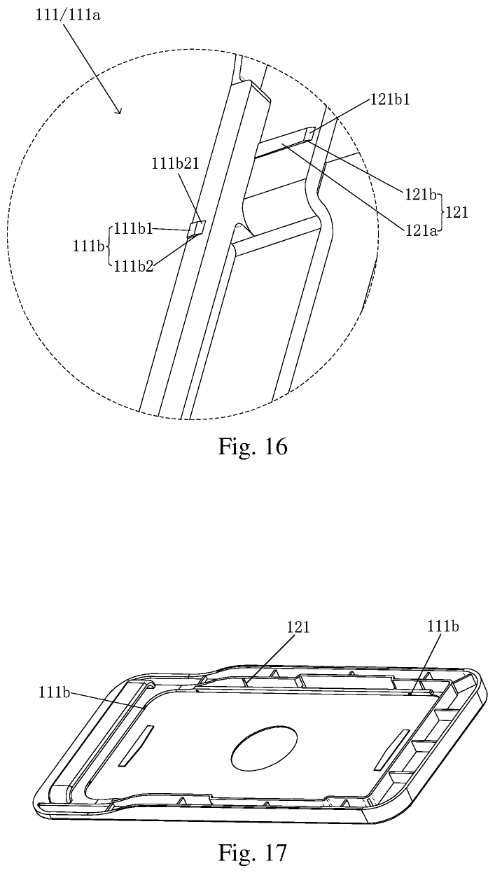

Optionally, as shown in FIG. 14, FIG. 16 and FIG. 17, the film pasting device 100 includes a first positioning side plate 120 and a second positioning side plate 130, the first positioning side plate 120 and the second positioning side plate 130 are arranged opposite to each other, the first positioning side plate 120 and the second positioning side plate 130 define the film fixed area 111 on the main board body 110; and a second projection 121 is arranged on an inner side wall of the first positioning side plate 120 and the second positioning side plate 130. During use, the first positioning side plate 120 and the second positioning side plate 130 frame the film pasting object, such that the screen is opposite to the protective film 200. However, machining errors exist when the first positioning side plate 120 and the second positioning side plate 130 are machined, and the machined first positioning side plate 120 and the second positioning side plate 130 are difficult to position the film pasting object well. In the present solution, a second projection 121 is arranged on the inner side wall of the first positioning side plate 120 and the second positioning side plate 130, and the second projection 121 may reduce machining errors and position the film pasting object well. In addition, the second projection 121 is arranged in a way that a large gap exists between the edge of the film pasting object and the inner wall of the first positioning side plate 120 and the second positioning side plate 130, so that when the film pasting object is framed, the air therein may be quickly discharged through the gap.

Optionally, as shown in FIG. 16, a second inclined surface 121b1 is arranged at an end, far away from the film fixed area 111, of the second projection 121. In the present solution, the second inclined surface 121b1 may play a role of guiding, to facilitate the first positioning side plate 120 and the second positioning side plate 130 to frame the film pasting object.

Optionally, as shown in FIG. 16, the second projection 121 includes a second flat part 121a and a second inclined part 121b, the second inclined part 121b is connected to an end, far away from the film fixed area 111, of the second flat part 121a; the thickness of the second inclined part 121b gradually thickens from an end far away from the second flat part 121a to an end near the second flat part 121a, thereby forming the second inclined surface 121b1 on the second inclined part 121b. In the present solution, the first inclined part 111b2 may play a role of guiding, to guide the film pasting object to the second flat part 121a, and the second flat part 121a may position well the protective film 200.

Optionally, as shown in FIG. 14 and FIG. 17, two second projections 121 are arranged on the inner side wall of the first positioning side plate 120 and the second positioning side plate 130; and the two first projections 121 are arranged at intervals. In the present solution, two second projections 121 are arranged on the inner side wall of the first positioning side plate 120 and the second positioning side plate 130, to position the film pasting object from all sides and have a good positioning effect; while the two second projections 121 are arranged at intervals to make the positioning of each side stable without shaking, and the positioning effect is favorable.

Optionally, as shown in FIG. 13, the film pasting device 100 further includes a third positioning side plate 170 and an arched bar 180; the first positioning side plate 120, the second positioning side plate 130 and the third positioning side plate 170 are enclosed on three sides of the film fixed area 111; the arched bar 180 is arranged on the main board body 110 and is located at a remaining side of the film fixed area 111, the arched bar 180 is arched relative to the main board body 110 to form an arched opening 181. In the present solution, the arched bar 180 is arranged for one reason that the arched bar 180 may define the film pasting object together with the first positioning side plate 120, the second positioning side plate 130 and the third positioning side plate 170, the film pasting object is defined from all sides, the film pasting device 100 is aligned accurately and simply, and is not easily deviated, and the defining effect of the film pasting object is favorable. Meanwhile, the arched bar 180 is arched to form an arched opening 181, the pull-up film 230 of the protective film 200 may penetrate through the arched opening 181 and extend out of the main board body 110, thereby improving the defining effect while not preventing the removal of the pull-up film 230. The second reason lies in that during film pasting, when the film pasting object is placed on a placing surface, for example, a table top, the arched bar 180 may prop up the pull-up film 230, such that the pull-up film 230 is still a certain distance away from the placing surface and is in a suspended state, instead of falling directly on the placing surface, to facilitate the operator to pull the pull-up film 230.

Optionally, as shown in FIG. 11, a circle of transparent area 116 is arranged around the pressing hole 112 on the main board body 110. In the present solution, it is convenient for the user to observe film pasting through the transparent area 116.

Specifically, as shown in FIG. 13, the film pasting device 100 and the protective film 200 form an assembly 10. The protective film 200 may be fixed in the film fixed area 111 through stickers 142.

Optionally, the film pasting device 100 includes a first positioning side plate 120, a second positioning side plate 130 and a fixed member 300, the first positioning side plate 120 and the second positioning side plate 130 are arranged opposite to each other, the first positioning side plate 120 and the second positioning side plate 130 define the film fixed area 111 on the main board body 110; the fixed member 300 is abutted against the inner side walls of the first positioning side plate 120 and the second positioning side plate 130, such that the fixed member 300 covers the film fixed area 111 and further fixes the protective film 200. In the present solution, the fixed member 300 may play a role of fixing the protective film 200, to prevent the protective film 200 from falling off from the film fixed area 111 in the transportation process. After a user picks up the film pasting device 100, the user may directly paste the film after removing the fixed member 300.

Optionally, clamping grooves 122 are arranged on the inner side walls of the first positioning side plate 120 and the second positioning side plate 130, protruding parts 310 corresponding to the clamping grooves 122 are arranged at two sides of the fixed member 300, and the protruding parts 310 are clamped into the clamping groove 122 and abutted against the clamping groove 122. In the present solution, the protruding part 310 and the clamping groove 122 are clamped and abutted, the effect of fixing the fixed member 300 is favorable, and the fixed member 300 is not easily shaken.

Optionally, an avoidance notch 190 is formed at an end part of the first positioning side plate 120; a lifting part 320 corresponding to the avoidance notch 190 is arranged on the side of the fixed member 300; and the lifting part 320 is arranged in the avoidance notch 190 when the fixed member 300 covers the film fixed area 111. In the present solution, the avoidance notch 190 and the lifting part 320 are arranged to enable the user to hold firmly, so as to lift the fixed member 300.

The above is a further detailed description of the present invention in combination with specific optional embodiments, and it cannot be assumed that the specific implementation of the present invention is limited to these descriptions. For those skilled in the art of the present invention, without departing from the premise of the concept of the present invention, a number of simple derivations or substitutions may be made, all of which should be regarded as falling within the protection scope of the present invention.

What is claimed is:

1. A film pasting device, comprising: a main board body, wherein the main board body is provided with a film fixed area for fixing a protective film, and a pressing hole is formed in the film fixed area on the main board body; and
the film fixed area is configured to be bonded with one side, deviating from a pull-up film, of a film body of the protective film, such that the protective film is connected to the main board body as a whole; the film body is disconnected from the film fixed area when pushing the side of the protective film deviating from the pull-up film after penetrating through the pressing hole.

2. The film pasting device of claim 1, wherein stickers are arranged at two ends of the film fixed area along a length direction, and the stickers are configured to stick the two ends of the protective film along the length direction, and the film fixed area is bonded with the side, deviating from the pull-up film, of the film body through the stickers, such that the protective film is fixed in the film fixed area.

3. The film pasting device of claim 1, wherein the film fixed area is sunk and set as a groove area.

4. The film pasting device of claim 3, wherein a first projection is arranged on a side wall of the groove area, and
a first inclined surface is arranged at an end, far away from a bottom surface of the groove area, of the first projection.

5. The film pasting device of claim 4, wherein the first projection comprises a first flat part and a first inclined part, the first inclined part is connected to an end, far away from the bottom surface of the groove area, of the first flat part; the thickness of the first inclined part gradually thickens from an end far away from the first flat part to an end near the first flat part, thereby forming the first inclined surface on the first inclined part.

6. The film pasting device of claim 4, wherein two first projections are arranged on the side wall of each side of the groove area; and the two first projections are arranged at intervals.

7. The film pasting device of claim 1, wherein the film pasting device comprises a first positioning side plate and a second positioning side plate, the first positioning side plate and the second positioning side plate are arranged opposite to each other, the first positioning side plate and the second positioning side plate define the film fixed area on the main board body; and a second projection is arranged on inner side walls of the first positioning side plate and the second positioning side plate.

8. The film pasting device of claim 7, wherein a second inclined surface is arranged at an end, far away from the film fixed area, of the second projection.

9. The film pasting device of claim 8, wherein the second projection comprises a second flat part and a second inclined part, the second inclined part is connected to an end, far away from the film fixed area, of the second flat part; the thickness of the second inclined part gradually thickens from an end far away from the second flat part to an end near the second flat part, thereby forming the second inclined surface on the second inclined part.

10. The film pasting device of claim 7, wherein two second projections are arranged on the inner side walls of the first positioning side plate and the second positioning side plate; and the two second projections are arranged at intervals.

11. The film pasting device of claim 1, wherein the film pasting device further comprises a first positioning side plate, a second positioning side plate, a third positioning side plate and an arched bar; the first positioning side plate and the second positioning side plate are arranged opposite to each other, the first positioning side plate, the second positioning side plate and the third positioning side plate are enclosed on three sides of the film fixed area; the arched bar is arranged on the main board body and is located at a remaining side of the film fixed area, and the arched bar is arched relative to the main board body to form an arched opening.

12. The film pasting device of claim 1, wherein a circle of transparent area is arranged around the pressing hole on the main board body.

13. The film pasting device of claim 1, wherein the film pasting device comprises a first positioning side plate, a second positioning side plate and a fixed member, the first positioning side plate and the second positioning side plate are arranged opposite to each other, the first positioning side plate and the second positioning side plate define the film fixed area on the main board body; the fixed member is abutted against the inner side walls of the first positioning side plate and the second positioning side plate, such that the fixed member covers the film fixed area and further fixes the protective film.

14. The film pasting device of claim 13, wherein clamping grooves are arranged on the inner side walls of the first positioning side plate and the second positioning side plate, protruding parts corresponding to the clamping grooves are arranged at two sides of the fixed member, and the protruding parts are clamped into the clamping groove and abutted against the clamping groove.

15. The film pasting device of claim 13, wherein an avoidance notch is formed at an end part of the first positioning side plate; a lifting part corresponding to the avoidance notch is arranged on the side of the fixed member; and the lifting part is arranged in the avoidance notch when the fixed member covers the film fixed area.
